(19) United States
(12) Patent Application Publication
(10) Pub. No.: US 2020/0227248 A1
(43) Pub. Date: Jul. 16, 2020

(54) Light Bulb Changing Device

(71) Applicants: Michael Lester O'Banion, Westminster, MD (US); Lowell Dean Leuking, Lake Wylie, SC (US); Todd James Huston, Leesburg, VA (US); Hugh Miskel, Marietta, GA (US)

(72) Inventors: Michael Lester O'Banion, Westminster, MD (US); Lowell Dean Leuking, Lake Wylie, SC (US); Todd James Huston, Leesburg, VA (US); Hugh Miskel, Marietta, GA (US)

(21) Appl. No.: 16/052,869

(22) Filed: Aug. 2, 2018

(51) Int. Cl. H01K 3/32; B25B 9/00

(52) U.S. Cl. CPC H01K 3/32; B25B 9/00

(57) ABSTRACT

A light bulb changing device with expandable fingers which can grasp all light bulbs within a size range between 1 inch and 6 inches diameter and all shapes of light bulbs including incandescent, compact fluorescent and LED having a screw thread base. The disclosed device is extendable to allow a person to install and remove light bulbs from an elevated ceiling without need for climbing a ladder. The device provides for a user to controllably expand the fingers to insert or remove a bulb at both the proximal (bottom)and distal (Ceiling) ends of the device so that a user can reach up to the ceiling, open the fingers to grasp the bulb using the proximal actuation, remove it, bring it down to reachable level, remove the used bulb using the distal actuation, insert a new bulb using the distal actuation, elevate the bulb to the ceiling screw it into the socket and using the proximal actuation open the fingers to complete the job. The disclosed device controls the torque with which the fingers grasp the bulb to prevent separation of the glass bulb from the metal base.

### FIELD OF THE INVENTION

The present invention relates to a device which may be used to change a light bulb which is beyond the reach of a person. More specifically, the present invention relates to a mechanical device designed to remove and replace a full range of light bulb sizes having a typical Edison screw base.

### BACKGROUND OF THE INVENTION

Numerous light bulb removal tools have been disclosed, manufactured and sold which alleviate the problems associated with replacing light bulbs from remote locations. One such problem is accessibility. Overhead lights are typically positioned on or in a ceiling of a room. Another problem is the adjustability of the handle to reach light bulbs at varying distances. Additionally, light bulbs of vastly different sizes and shapes are available. Another problem is light bulbs are subject to separation from their metal base if the user applies too much torque while installing. A typical light bulb is tightened to a torque of approximately between 10 and 20-inch pounds regardless of the size of the bulb. Another problem is not providing adequate assurance that the device will hold the bulb without the chance of dropping the bulb and breaking it. Another problem is that many light bulb changing devices do not provide the ability for the user to actuate the mechanism from both the proximal (bottom handle) or distal (upper gripping end) ends. This is necessary to permit a user to install and remove a bulb at a workable height and yet be able to grip and release the bulb at an elevated, not human reachable, height.

U.S. Pat. Nos. 1,202,432 and 1,201,506 to Rozelle et al., both disclose an adjustable device for placing and removing electric light bulbs. The patent teaches that the rods are adjustable to reach light bulbs at different heights, but the mechanism to lock the rods at a desired height is cumbersome. The mechanism to prevent the sliding of the rods consists of pins positioned along the rod which are configured to slide into a bayonet slot cut into the outer surface of the rod. Therefore, the user can only adjust the rod at certain heights, which is burdensome if the light bulb is at a height that does not correspond to any of the positions available on the rod. Further, this patent discloses spring fingers that are actuated by an adjusting spider. Said fingers are limited in adjustment range to a single size bulb. Further, the mechanism to actuate the gripping fingers is only actuatable by the user from the proximal end opposite the fingers, which creates difficulty inserting a replacement bulb into the fingers, due to the necessity of opening and closing the fingers from the proximal end. This invention also does not control the amount of torque which can be applied to a light bulb regardless of the size of the bulb.

U.S. Pat. No. 1,121,759 to Printiss discloses a manually operable device for quickly and safely replacing lamp sockets and bulbs placed beyond the reach of the operator's arm. This patent teaches the use of a compression spring to impart a force on the plurality of clamps and a cord and pulley to guide the cord to a proximal end of the number of jointed sections of handle. This patent also teaches use of a lever and pivot for mechanical advantage reducing the force the operator would need to pull the cord against the force of the compression spring. This invention also does not control the amount of torque which can be applied to a light bulb regardless of the size of the bulb.

U.S. Pat. No. 1,514,814 to Allen, discloses an electric bulb holder which has bulb gripping arms that are pivotally connected to a slidable member which causes the bulb gripping arms to spread around the light bulb and then collapse to grip the light bulb. Once the user has a grip of the light bulb, he must rotate the whole bulb holder to screw or unscrew the light bulb. The means for closing and opening the fingers is by use of a thumb nut and feed screw only actuatable at the distal, or finger end of the device thereby rendering actuation of the fingers at an elevated location difficult or impossible. This invention also does not control the amount of torque which can be applied to a light bulb regardless of the size of the bulb.

U.S. Pat. No. 1,926,948 to Iffland discloses a light bulb changer that has spring fingers that can be regulated to cooperate with different sized bulbs. The spring fingers change their normal shape by manual adjustment of the collar at the distal, finger end of the device. The fingers are only actuatable at the distal, or finger end of the device, thereby rendering actuation of the fingers at an elevated location difficult or impossible. Further, the geometry of the fingers and collar do not provide a large range of adjustment. This invention also does not control the amount of torque which can be applied to a light bulb regardless of the size of the bulb. This invention does not provide the ability to adjust the fingers from both the proximal and distal ends.

U.S. Pat. Nos. 2,357,104 and 2,357,105 to Grinnell, discloses a light bulb changer with pivotable jaws with gripping pads. Said jaws are openable and closable to grip bulbs of widely differing sizes. The patent teaches that the jaws are closable with a compression spring pushing on a wedge cone to close the jaws. Additional extension springs, 20, are employed to open the jaws and a cord is used to actuate the jaws from a proximal end. This invention also does not control the amount of torque which can be applied to a light bulb regardless of the size of the bulb. This invention does not provide the ability to adjust the fingers from both the proximal and distal ends.

U.S. Pat. No. 2,594,908, Gaulke, teaches of a grappling device with resilient grappling means which may be manipulated from the handle portion of the tube. The problem which this invention does not solve is that the grappling means or gripping fingers, when in the most extended position, have very low gripping force due to the very small amount of leverage applied to the fingers. This invention also does not control the amount of torque which can be applied to a light bulb regardless of the size of the bulb. This invention does not provide the ability to adjust the fingers from both the proximal and distal ends.

U.S. Pat. No. 2,616,743 to Negley discloses a light bulb changer having a rigid handle and a bendable arm attached to the handle. Although this light bulb changer allows the user to bend the arm to engage light bulbs at different angles, the light bulb changer does not allow the user to adjust the handle to different heights. Further, the light bulb changer taught by Negley does not allow the user to adjust the mechanism to fit differently sized light bulbs. This invention also does not control the amount of torque which can be applied to a light bulb regardless of the size of the bulb. This invention does not provide the ability to adjust the fingers from both the proximal and distal ends.

U.S. Pat. No. 2,983,541 to Maki discloses a device for removing or placing light bulbs in sockets. Specifically, the device taught by Maki consists of a fixed rod with a bendable arm for reaching light bulbs at different angles. The patent discloses using a helicoidal operating member inside the bendable arm which is bendable and rotatable. However, the device taught by Maki, by having a fixed rod, does not allow the user to adjust the rod to different heights. Also, the user must use an air bulb to create suction in an engaging cup to engage the light bulb. This is disadvantageous to the user, because the cup is not adjustable to engage different sized light bulbs. This invention also does not control the amount of torque which can be applied to a light bulb regardless of the size of the bulb. This invention does not provide the ability to adjust the fingers from both the proximal and distal ends.

U.S. Pat. No. 4,663,996 to Grudgefield, identifies that incandescent light bulbs are well known and have a metallic base and a glass envelope with a substantially hemispherical end or tip. Irrespective of whether the base is an Edision-Swan screw thread or a bayonet cap fitting, in order to change the light bulb it is necessary to apply a twisting force to the glass envelope in order to both engage and disengage the light bulb from its fitting. In addition, the increasingly prevalent use of aluminum instead of brass in the base of the bulb has tended to increase problems caused by the bending or other malfunction of the base. A common fault is that the bond between the glass envelope and the base is broken. Grudgefield identifies that a twisting force is necessary to screw or unscrew the bulb, and he identifies the problem of breaking bulbs or separating them from their Edison screw base but he does not identify a solution of controlling the torque applied to the bulb to prevent such an occurrence. This invention does not provide the ability to adjust the fingers from both the proximal and distal ends.

U.S. Pat. No. 4,719,826 to DuBois discloses a light bulb extractor with a steel U-shaped pair of gripping arms formed from steel having the proper size and shape to fit over the end of a lamp bulb. The tips of the gripper arms are formed to fit the end of the bulb and the steel is then annealed to obtain the required spring characteristics. The tips of the gripping arms are covered with plastic to provide friction between the gripping arms and the bulb. A chain is attached between the arms with a second chain attached to its center. Pulling the second chain will close the gripping arms. A slot is provided to secure the second chain to hold the arms at any desired span. Extensions can be attached to the gripper arms when the device is used on high overhead lamps. The steel used in the gripper arms is thin to fit between the bulb and fixture when the bulb is mounted in deep fixtures. DuBois also identifies the need for friction between the fingers and the bulb but does not identify a solution to control the torque of the fingers. The patent does disclose the use of a chain to be pulled by the operator to grip the bulb such that the operator must pull the chain and turn the device to screw or unscrew the bulb simultaneously which is a difficult operation for some individuals. This invention also does not control the amount of torque which can be applied to a light bulb regardless of the size of the bulb.

U.S. Pat. No. 5,317,939, Marinescu, teaches a light bulb changing device including an extended pipe, an annular head is connected to an upper end of the pipe. A finger clamp assembly is carried within the annular head. A handle is slidable within a lower end of the pipe and is depressible by another hand of the person. A structure is coupled to the handle within the pipe for operating the finger clamp assembly. The finger clamp assembly can grip a light bulb to install and remove the light bulb from a lighting fixture at an elevated position from a floor. The invention utilizes a compression spring to apply a force to the spring fingers to grip a light bulb however Marinescu does not identify a solution to controlling the torque applied to the light bulb. Further, while the invention provides that the device may have an extended pole to access elevated light bulbs, the invention does not provide a means to open the fingers at the distal or finger end of the device so as to allow insertion of a new light bulb. This invention does not provide the ability to adjust the fingers from both the proximal and distal ends.

U.S. Pat. No. 6,883,400 Sugano, describes a device for changing a light bulb comprising an outer tube and an inner tube positioned inside the outer tube, wherein the tubes are adjustable along a longitudinal axis. The inner tube having a rotating member which is rotatable about the longitudinal axis by a grip attached to the inner tube. The device comprising a flexible arm with a flex cable running through the arm, wherein the arm is connected to the outer tube. The flex cable in the flexible arm rotates in agreement with the rotating member by means of a transferring mechanism and drives a clasping mechanism comprising a plurality of spring urged fingers. The spring urged fingers are adjustable to clasp different sized light bulbs by a sliding collar coupled to the clasping mechanism. This device has several problems inherent to the invention. Ceiling light bulbs are typically a minimum of 8 feet above the floor requiring that the light bulb changer must be extended to a dimension allowing a normal person to reach the light bulb with the changing device. To remove a light bulb from an extended location the user must adjust the sliding collar and spring fingers when the head unit is located at a person-reachable location. This adjustment must be made to allow the fingers to impart adequate torque to remove the light bulb. The user can only guess what the proper adjustment of the sliding collar must be. If the adjustment is made incorrectly then the sliding collar must be readjusted, possibly multiple times. This presents a cumbersome process for removing a light bulb. Further, the disclosed device is unduly complicated creating a very expensive execution. This invention also does not control the amount of torque which can be applied to a light bulb regardless of the size of the bulb. This invention does not provide the ability to adjust the fingers from both the proximal and distal ends.

### SUMMARY OF THE INVENTION

A primary object of the present invention is to provide a light bulb changing tool that will overcome the shortcomings of the prior art devices.

Another object is to provide a light bulb changing tool that will grip a light bulb at an upper end, so that the light bulb can be installed or removed from a ceiling outlet located at an elevated position above a floor.

An additional object is to provide a light bulb changing tool that is adaptable to grip and stabilize various sized and shaped light bulbs, so that each light bulb can be properly installed and removed from the ceiling outlet.

Another object of the invention is to provide a light bulb changing device that can be actuated by the user from either the distal or proximal end and that the actuation force is reduced so that older or weaker individuals can easily operate the device. Operation from the distal end allows a user to insert or remove a bulb while working at the distal end. Operation from the proximal end allows the user to grab or release a bulb when the distal end is at an elevated position not reachable by the user.

An additional object of the invention is to provide a light bulb changing device that can be adjusted in length to accommodate use for various ceiling heights.

A further object is to provide a light bulb changing tool that is simple and easy to use.

A still further object is to provide a light bulb changing tool that is economical in cost to manufacture.

A further object of the invention is to provide a light bulb changing device that controls the amount of torque applied to the light bulb so as to avoid causing the glass bulb being broken away from the metal Edison thread, and yet to have enough torque to remove a difficult bulb.

Further objects of the invention will appear as the description proceeds.

### BRIEF DESCRIPTION OF THE DRAWINGS

FIG. 1 is a view of the full length of the disclosed light bulb changer, (to be abbreviated subsequently as lbc) showing the distal end with flexible fingers shown in the retracted position and proximal end shown with the retraction reel and handle.

FIG. 2 is a view of the distal end shown with the flexible fingers shown in the opened position

FIG. 3 is a view of the distal end shown with the flexible fingers in the retracted position.

FIG. 4 is a view of a portion of the internal mechanism located at mostly the distal end showing the compression spring and retraction cable and pulleys.

FIG. 5 is a view of the proximal end showing the cable retraction and gripping mechanism.

FIG. 5a is a cross sectional view of the cable gripper which is utilized to releasably grip the cable in a first direction while allowing release in a second direction.

FIG. 6 is a schematic view of the distal end with the flexible fingers in the retracted position and showing locations and directions of the forces which are applied to the flexible fingers by the compression spring.

FIG. 7 is a schematic view of the distal end with the flexible fingers in a first intermediate opened position and showing locations and directions of the forces which are applied to the flexible fingers by the compression spring.

FIG. 8 is a schematic view of the distal end with the flexible fingers in a second intermediate opened position and showing locations and directions of the forces which are applied to the flexible fingers by the compression spring.

FIG. 9 is a schematic view of the distal end with the flexible fingers in a fully opened position and showing locations and directions of the forces which are applied to the flexible fingers by the compression spring, and table 1.

### DETAILED DESCRIPTION OF THE PREFERRED EMBODIMENTS

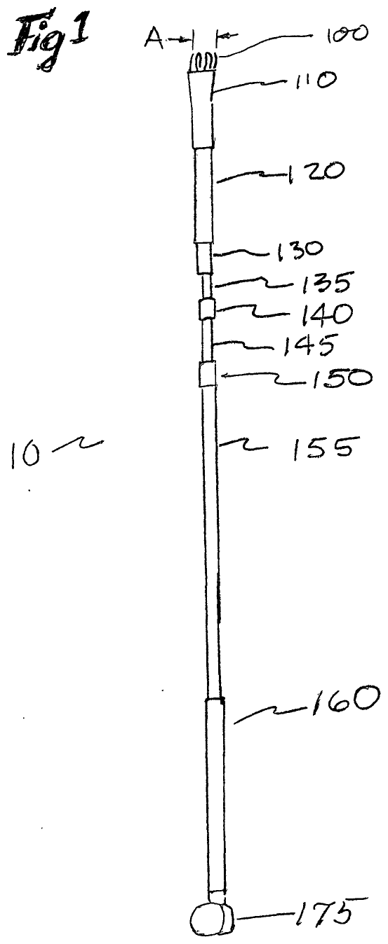

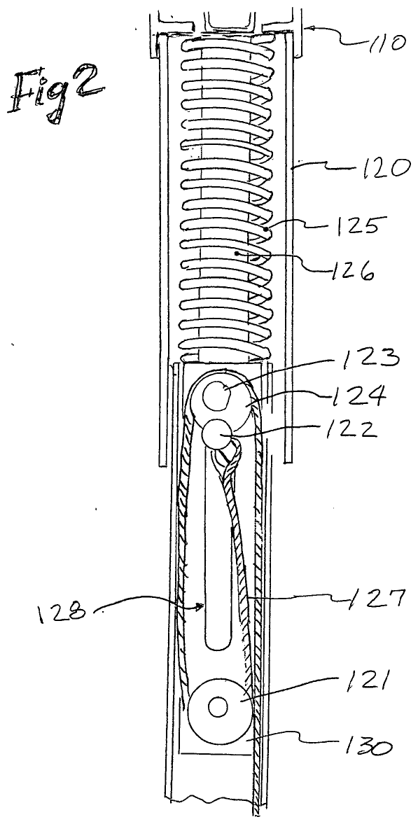

FIG. 1 shows, at a distal end of the disclosed light bulb changer, from here on to be abbreviated to lbc, flexible fingers 100, said fingers having a preferred curvilinear shape, said fingers shown in the fully retracted position, dimension A, a horn 110 which helps to control the position of the at least two flexible fingers, a tube 120 which encases a compression spring which is shown in FIG. 2. Also shown is a pulley housing 130, a small diameter extension tube 135, a small bushing 140 which provides a low friction sliding surface between said metal tubes such that metal does not slide against metal, an intermediate diameter extension tube 145, a large bushing 150 used to prevent metal-to-metal sliding, large diameter extension tube, said more than one extension tubes and said bushings combine to provide a set of at least two telescoping extension tubes to allow the user to expand or contract along an axial direction to provide for a greater or lesser axial length for the purpose of allowing the user to extend his reach to lower or higher positioned light bulbs, and at a proximal end of said lbc, a sliding handle which is fixedly connected to a take up reel 175, said sliding handle is slid in an axial direction opposite from the flexible fingers for the purpose of expanding the flexible fingers to a larger dimension suitable to grasp a variety of light bulb sizes, said bulbs having diameters between approximately 1.5 inches to approximately 5.5 inches, then said slide handle is released allowing said flexible fingers to grasp the light bulb at the preferred torque to assure bulb removal but limiting said torque to between approximately 5 and 25 inch pounds that will not cause the glass bulb to separate from the metal base of the bulb.

FIG. 2 illustrates said horn 110 shown expanded in an axially distal direction allowing said flexible fingers to be forced to a closed smallest dimension. Flexible fingers illustrated in FIG. 1 have a natural shape and a compressed shape. The compressed shape is of a dimension A to grasp the smallest of light bulbs. The natural shape of said flexible fingers is such that it is much larger than dimension A. Said horn is fixed to a tube 120. A compression spring 125 is shown in an axially largest condition. A connecting rod, 126 is shown, said connecting rod is fixedly connected to said flexible fingers on a central axis, said connecting rod also is fixedly connected to a pulley housing 130, said pulley housing encasing a moving pulley 124, a fixed pulley 121 and a pin 122. Said pin and moving pulley are moveable in a slot 128, provided in said pulley housing and said moving pulley and said pin are fixed to said tube. A cable 127, or any flexible tension member known in the art, having a first end and a second end is routed around said moving pulley, said fixed pulley and said second end is terminated at said pin. Said cable, said fixed and moving pulleys act together as a system to improve the mechanical advantage for an operator to more easily actuate said light bulb changer from the proximal end. Said cables first end is guided preferably through the annulus of tubes 135, 145, and 155 and guided to terminate said first end at said reel shown in FIG. 1. The function of adjusting said flexible fingers to a preferred dimension, dimension A or larger than dimension A, to allow the user to grasp a light bulb of a certain size is accomplished in a first method and a second method. The first method is utilized when an operator is removing a light bulb from a ceiling fixture. The operator first extends the telescoping pole to a preferred length to permit access to the bulb. He then grips the large extension tube with a first hand and grips the sliding handle with a second hand. He then pulls the sliding handle axially in a proximal direction which expands the flexible fingers to a preferred dimension to allow said fingers to grip the bulb. He then releases the sliding handle which allows the compression spring to force the horn in a distal direction to in turn apply force on the flexible fingers to grip the bulb. He then rotates the light bulb changer 10 and light bulb counterclockwise to unscrew the bulb. The second method is then used to extract the bulb from the grip of the flexible fingers and insert a new replacement bulb. The operator does this by placing the reel end against the floor of the room and with a first hand grips the tube 120 and with a second hand he grips the bulb. He then slides the tube in a direction toward the proximal, reel end of the light bulb changer thereby releasing the grip of the flexible fingers on the bulb.

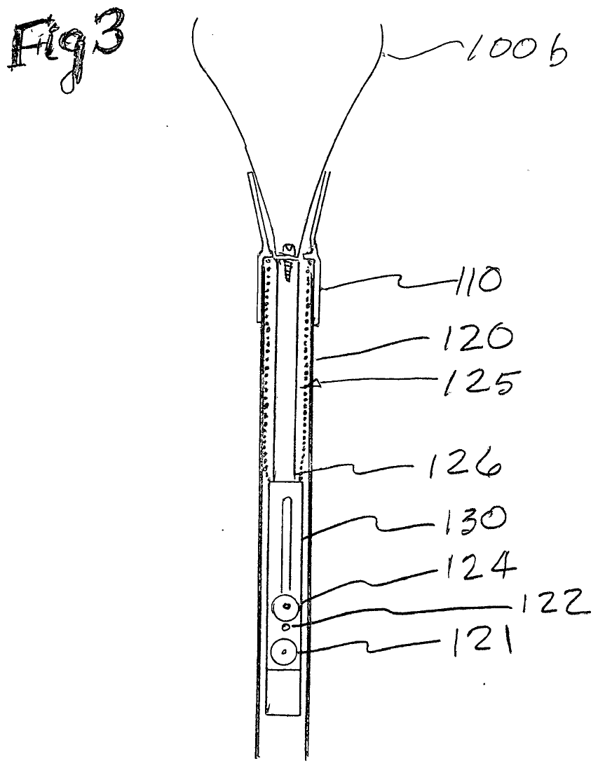

FIG. 3 illustrates the light bulb changer 10 with said horn moved axially toward the proximal end of the light bulb changer. Said horn is shown in its fully proximal position which compresses said compression spring to its fully compressed condition. Said horn when in said position allows the at least two flexible fingers to expand to their fully expanded position of preferably between 4 to 6 inches.

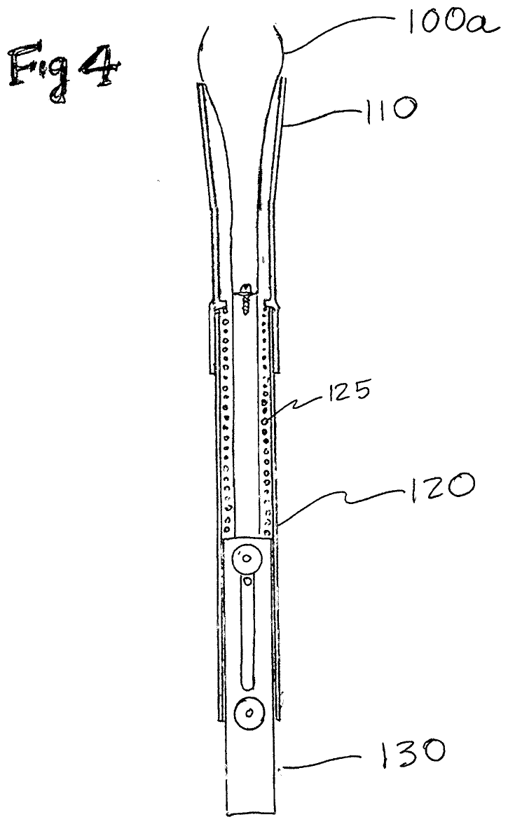

FIG. 4 illustrates the light bulb changer 10 with said horn moved axially toward the distal end of the light bulb changer. Said horn is shown in its fully distal position which compresses said compression spring to its least compressed condition. Said horn when in said position forces the at least two flexible fingers to close to their fully closed position of preferably between 1 to 3 inches.

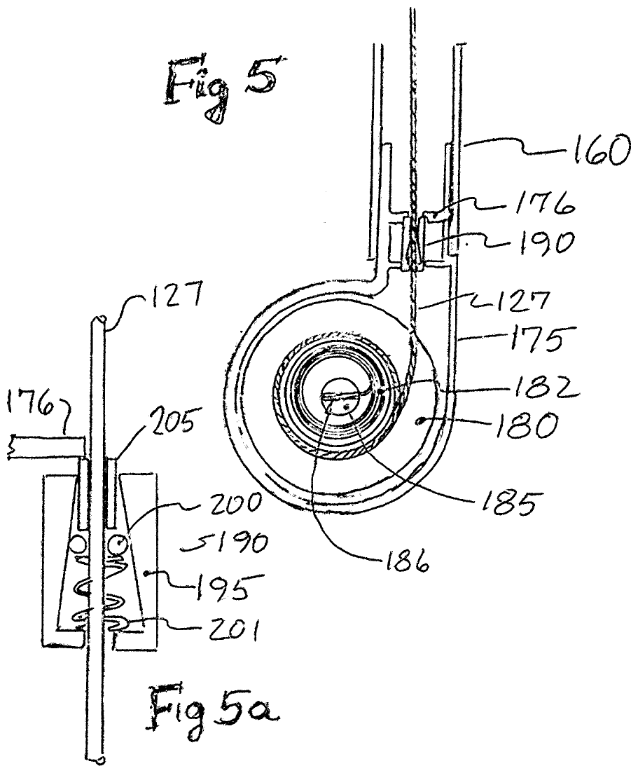

FIG. 5 illustrates the proximal end of said lbc. Slide handle 160 is fixedly connected to take up reel 175 which encases drum 180, said drum encases a torsion spring on a common axis, said torsion spring is commonly known as a clock spring, said torsion spring 182, having a first and second end, the first end is attached to the inside diameter of said drum said second is attached to a slot 186, in a spring axle 185 which may be molded as part of take up reel. Said reel also encases a cable gripper 190 shown in greater detail in FIG. 5a. Cable 127, being preferably fed through said annulus of said small medium and large diameter tubes from said distal end of the lbc is then guided through said cable gripper, then guided around said drum at least one full circumference and said first end of said cable is fixedly terminated on said drum. When the lbc is in a first condition of the extension tubes at their most fully extended axial length said drum will have a preferred at least one full circumference of said cable wrapped around said drum. In this condition said torsion spring will be at its most fully wrapped condition. When the lbc is in a second condition of the extension tubes being at their smallest axial dimension, said torsion spring forces said drum to rotate thereby wrapping said cable around said drum, and said torsion spring is at its least wrapped condition. When the operator locks said pole at a preferred pole extended dimension, said cable gripper is in its gripping position so that when the operator actuates said sliding handle said cable gripper will grip said cable so that said cable will actuate said pulleys and horn and flexible fingers at said distal end of said lbc.

FIG. 5a illustrates detail function of said cable gripper. Cable gripper 190 is comprised of a tapered housing 195, which has a conically shaped internal lumen. At least 2 spherical balls ride on said internal conical lumen and are forced to a smallest end of said conical lumen by a compression spring 201. An annular shaped sleeve 205, with a length and inner diameter and an outer diameter is placed around said cable. The purpose of said cable gripper is to prevent the cable from unwrapping from said drum when said first method of adjusting said flexible fingers to a preferred dimension is being used. As said slide handle is moved in an axial direction toward the proximal end of said lbc said balls are forced toward the smallest end of said conical lumen thereby gripping said cable and preventing said cable from unwrapping from said drum.

When an operator wishes to utilize said second method of adjusting the dimension of said flexible fingers, said cable gripper is in the condition where said balls are gripping said cable. The operator grips said tube with a first hand and axially slides said tube and horn in a proximal direction which moves moving pulley 124 and pin 122 to a reduced axial dimension to said fixed pulley 121 thereby making said cable to have slack since said pulleys have been moved closer together. The slack cable is then wrapped around said drum due to the torque imparted to said drum from said torsion spring.

When the operator wishes to extend said extension tubes to a longer axial dimension, said slide handle and reel and cable gripper are pulled in a minimally axially distal direction by the force of the operator extending said extension tubes until said cable gripper is stopped from said axial movement by wall 176 which pushes said sleeve 205 which in turn push balls 200 thereby releasing the balls' grip on said cable. Wall 176 may be molded as an integral part of said reel.

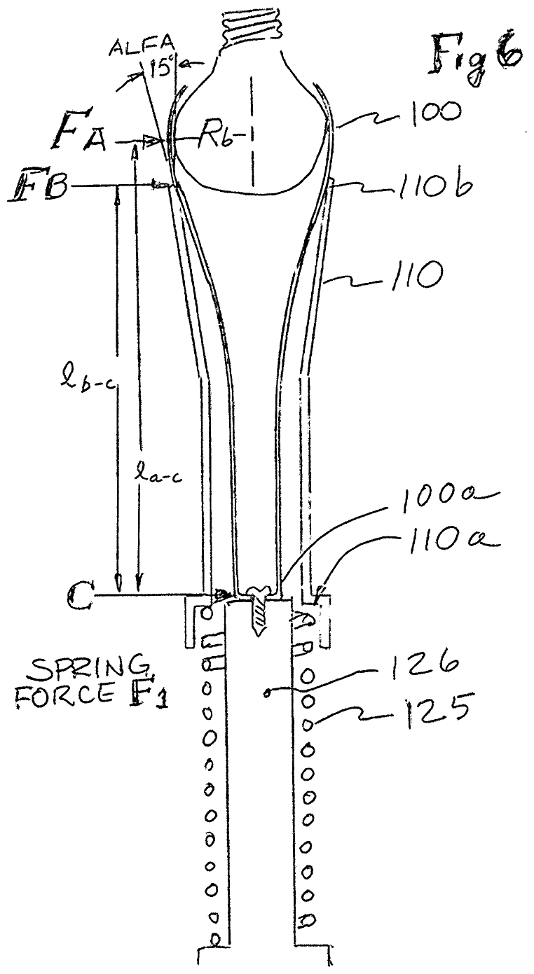

FIG. 6 illustrates said flexible fingers in a condition of being forced to their smallest dimension “A” by said Horn by contacting said flexible fingers at point 110b. Compression spring 125 produces a force F1 in an axially distal direction on said horn through an angle alfa which is the angle of said spring finger to said axis of lbc. Force F1 acting through said angle alfa produces a force Fb on said flexible fingers in a direction perpendicular to the axis of said lbc. Said flexible fingers then produce a force Fa on the perimeter of the light bulb. Force Fa is a normal force on the perimeter of the light bulb which causes a force of friction acting through the coefficient of friction between the light bulb and said spring finger. A stated object of this invention is to control the torque applied to said light bulb so as to not cause failure of the glass light bulb to metal base connection. Torque is a function of the following dimensions and angles illustrated in Table 1. Force F1, Force Fa, Force Fb, radius of bulb Rb, distance La-b, distance La-c and coefficient of friction μ between flexible fingers and light bulb.

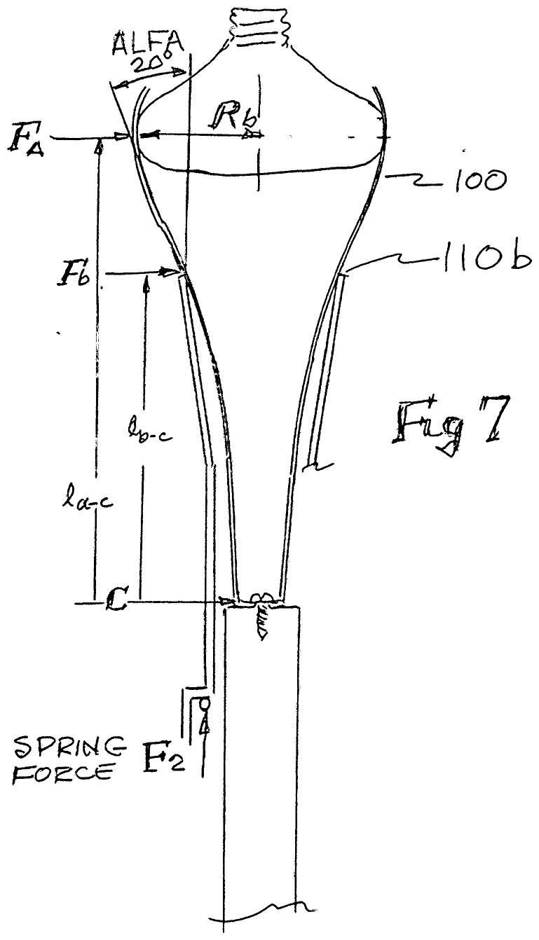

FIG. 7 illustrates said flexible fingers in a condition being forced to an intermediate dimension “B” by said Horn by contacting said flexible fingers at point 110b. In this intermediate position of said horn, said compression spring is in a state of greater compression as compared to the position illustrated in FIG. 6 thus force F2 is higher than said force F1. Said Force F2, Force Fa, Force Fb, radius of bulb Rb, distance La-b, distance La-c are all different than illustrated in FIG. 6 as they change continuously as said horn to said flexible fingers position changes.

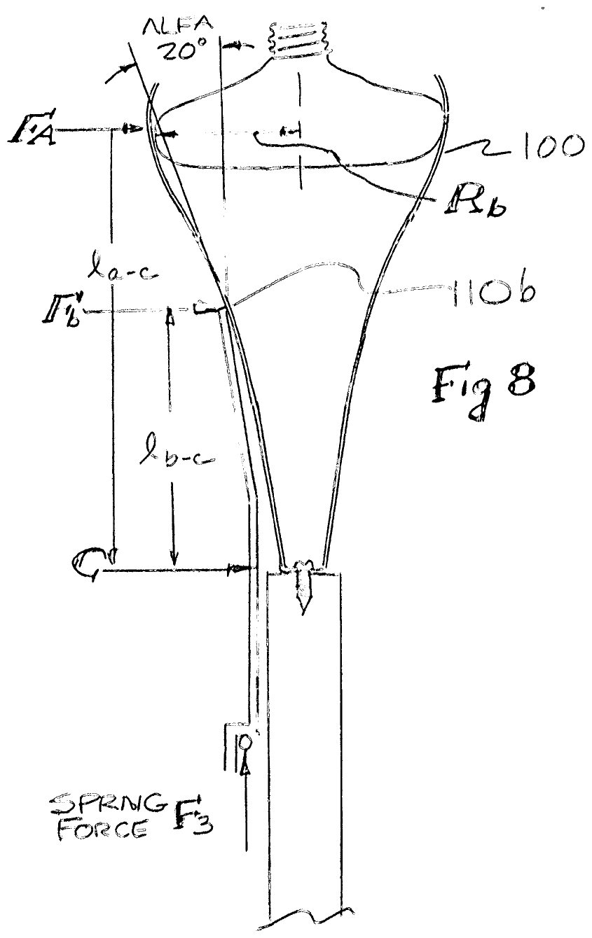

FIG. 8 illustrates said flexible fingers in a condition being forced to an intermediate dimension “C” by said Horn by contacting said flexible fingers at point 110b. In this second intermediate position of said horn, said compression spring is in a state of greater compression as compared to the position illustrated in FIG. 7 thus force F3 is higher than said force F2. Said Force F3, Force Fa, Force Fb, radius of bulb Rb, distance La-b, distance La-c are all different than illustrated in FIG. 7 as they change continuously as said horn to said flexible fingers position changes.

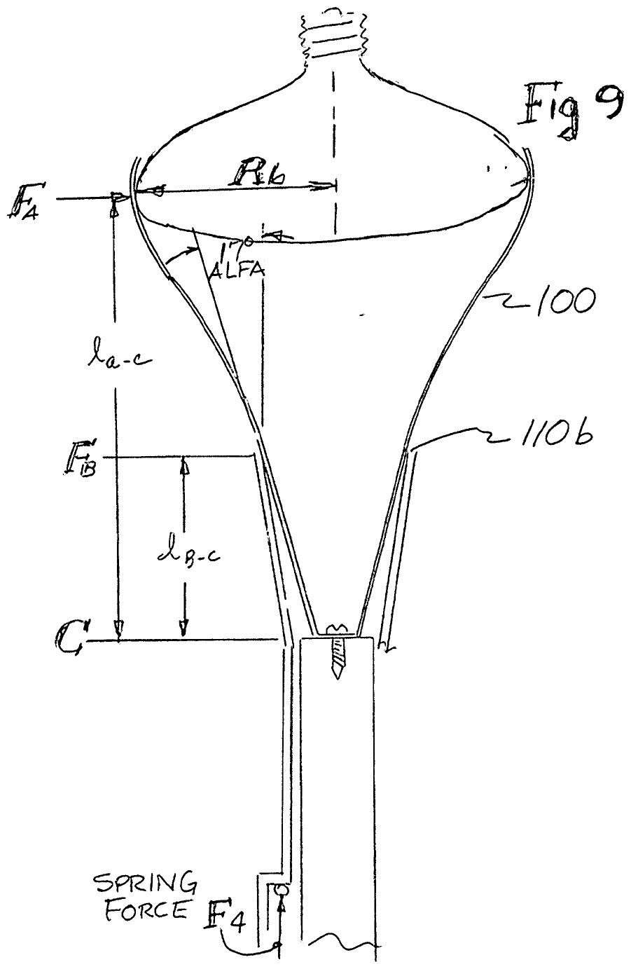

FIG. 9 illustrates said flexible fingers in a condition being forced to an intermediate dimension “D” by said Horn by contacting said flexible fingers at point 110b. In this position of said horn, shown in its most axially retracted position, said compression spring is in a maximum state of compression as compared to the position illustrated in FIG. 8 thus force F4 is higher than said force F3. Said Force F4, Force Fa, Force Fb, radius of bulb Rb, distance La-b, distance La-c are all different than illustrated in FIG. 7 as they change continuously as said horn to said flexible fingers position changes. Using the geometry and forces illustrated in FIG. 6 through FIG. 9 exemplary calculations are illustrated at said four positions of said horn to said flexible fingers resulting in predicted torques applied to light bulbs of dimensions A, B, C and D.

TABLE 1
The object is to calculate the torque applied to tighten of loosen the bulb
Referring to FIG. 6
the spring force increases as it is compressed
the force that the horn applies to the fingers changes due the angle alfa and the ratio of Lb-c/La-c
the torque applied to the bulb increases as the bulb diameter increases
Spring force is measured a the 4 different points
Fb is calculated by dividing it by the tangent of Alfa
Fa is calculculated by doing the sum of moments about C
Fb × Lb-c − Fa × La-c = 0
Fa = Fb(Lb-c/La-c)
Torque applied to bulb = Fa × coefficient of friction × radius of bulb

| | | ANGLE ALFA | | | | | RATIO | | | FRICTION | TORQUE |
|---|---|---|---|---|---|---|---|---|---|---|---|
| SPRING FORCE | | ALFA | RADIANS | Fb | La-c | Lb-c | Lbc/Lac | Fa | Rb | Coefficient | ON BULB |
| F1 | 11.0 | 15.0 | 0.3 | 42.2 | 5.0 | 4.5 | 0.9 | 38.0 | 0.9 | 0.3 | 10.0 |
| F2 | 14.6 | 20.0 | 0.3 | 41.3 | 5.0 | 3.6 | 0.7 | 29.7 | 1.4 | 0.3 | 12.3 |
| F3 | 17.7 | 20.0 | 0.3 | 50.0 | 5.0 | 3.0 | 0.6 | 30.0 | 1.8 | 0.3 | 15.8 |
| F4 | 21.0 | 17.0 | 0.3 | 70.6 | 5.0 | 2.1 | 0.4 | 29.7 | 2.3 | 0.3 | 20.6 |

Thus, the object of the invention to control the torque applied to the light bulb is demonstrated. The invention may have greater or lesser dimension, forces and angle alfa and are still within the scope of the invention

What is claimed is:

1) a light bulb changing device comprising:
a) a rod having first and second ends;
b) at least two flexible fingers connected to the rod adjacently to the first end; having a predetermined curvilinear shape and a predetermined length;
c) a horn slidably disposed on the rod and covering at least part of the flexible fingers, the horn being movable between a first position at a first distance from the first end and a second position at a second distance from the first end;
d) a compression spring biasing the horn towards the first position;
e) a flexible tension member connected to the horn and extending adjacently to the rod said tension member may be any one or combination of tension members like cable, rope, ribbon, wire, belt or the like; and;
f) actuation of the device at the first end of the rod and;
g) actuation of the device at the second end of the rod

2) the light bulb changing device according to claim 1 further comprising:
a) a set of at least 2 rods, the second rod having a first and second end, the first end being approximately adjoined to the second end of the first rod, said rods may be telescoping tubes

3) the light bulb changing device of claim 2 further comprising at a second end of the second rod or tube
a) a take up reel
b) a drum
c) a torsion spring to apply torque to the drum

4) the light bulb changer of claim 3 further comprising cable gripping means

5) The light bulb changer of claim 2 further comprising at least one pulley to reduce the force required to actuate the device

6) The light bulb changing device of claim 3 further comprising at least one pulley to reduce the force required to actuate the device

7) The light bulb changing device of claim 4 further comprising at least one pulley to reduce the force required to actuate the device

8) The light bulb changing device of claim 5 further comprising cable gripping means

9) The light bulb changing device of claim 2 further comprising cable gripping means

10) a light bulb changing device comprising:
a) a rod having first and second ends;
b) at least two flexible fingers connected to the rod adjacently to the first end; having a predetermined curvilinear shape and a predetermined length such that the fingers will open to hold a bulb between approximately 1 inch diameter and 6 inches diameter
c) a horn slidably disposed on the rod and covering at least part of the flexible fingers, the horn being movable between a first position at a first distance from the first end and a second position at a second distance from the first end;
d) a compression spring biasing the horn towards the first position and providing a torque to grip the range of bulbs at a torque between approximately 5 to 25 inch pounds of torque;
e) a flexible tension member connected to the horn and extending adjacently to the rod which may be any one or combination of tension members like cable, rope, ribbon, wire, belt or the like; and;
f) actuation of the device at the first end of the rod and;
g) actuation of the device at the second end of the rod

11) the light bulb changing device according to claim 10 further comprising:
a) a set of at least 2 rods, the second rod having a first and second end, the first end being approximately adjoined to the second end of the first rod, said rods may be telescoping tubes

12) the light bulb changing device of claim 11 further comprising at a second end of the second rod or tube
a) a take up reel
b) a drum
c) a torsion spring to apply torque to the drum

13) the light bulb changer of claim 12 further comprising cable gripping means

14) The light bulb changer of claim 11 further comprising at least one pulley to reduce the force required to actuate the device

15) The light bulb changing device of claim 12 further comprising at least one pulley to reduce the force required to actuate the device

16) The light bulb changing device of claim 15 further comprising at least one pulley to reduce the force required to actuate the device

17) The light bulb changing device of claim 14 further comprising cable gripping means

18) The light bulb changing device of claim 11 further comprising cable gripping means
